(19) United States
(12) Patent Application Publication
(10) Pub. No.: US 2011/0161220 A1
(43) Pub. Date: Jun. 30, 2011

(54) Method and System for Monitoring Financial Market Trading Activity to Establish and Track Aggregate Trading Limits Based on Trading Sub-Limits Assigned by Prime Brokers for Particular Trading Entities

(75) Inventors: Lee Arthur Cole, Evergreen, CO (US); Douglas Guy Kittelsen, Evergreen, CO (US); Malcolm Gary LaFever, Lyons, CO (US); Ted Nathan Myerson, Boynton Beach, FL (US)

(73) Assignee: FTEN, Inc., New York, NY (US)

(21) Appl. No.: 12/914,699

(22) Filed: Oct. 28, 2010

Related U.S. Application Data
(60) Provisional application No. 61/255,772, filed on Oct. 28, 2009.

(51) Int. Cl. G06Q 40/00

(52) U.S. Cl. 705/37

(57) ABSTRACT

The present invention relates to systems and methods for monitoring market transaction activity data to determine when a trading entity has exceeded an aggregated limit consisting of one or more trading sub-limits corresponding to one or more custodial prime brokers facilitating trading for the trading entity. The method includes collecting at a centralized hub real time data related to conditions of a trading market from one or more liquidity destinations trading at least one financial article of trade. Trading activity for a trading entity is determined. An aggregate trading limit is determined that is based on one or more trading sub-limits assigned by one or more prime brokers for that trading entity. It is determined when that trading activity exceeds the aggregate trading limit.

### CROSS REFERENCE TO RELATED APPLICATIONS

The present invention claims priority to and the benefit of U.S. Provisional Patent Application No. 61/255,772, filed on Oct. 28, 2009, entitled “Method And System For Monitoring Financial Market Trading Activity To Establish And Track Aggregate Trading Limits Based On Trading Sub-Limits Assigned By Prime Brokers For Particular Trading Entities,” to Cole et al., which is herein incorporated by reference in its entirety.

### BACKGROUND OF THE INVENTION

1. Field of the Invention

The present invention relates to system for consolidating and analyzing intraday issues related to securities transactions that have been submitted to liquidity destinations via multiple prime broker relationships.

2. The Relevant Technology

The prime brokerage landscape (i.e., investment banks providing global custody (including clearing, custody, and asset servicing), securities lending, financing (to facilitate leveraging of client assets to enable investment of greater amounts than actually on deposit), capital introduction, and similar services to hedge funds, proprietary trading groups and other professional trading entities) has changed dramatically since the collapse of Lehman Brothers in 2008. Trading entities that received credit (a.k.a. “margin”) financing from Lehman Brothers could not withdraw their collateral when Lehman declared bankruptcy due to lack of adequate asset protection rules.

As a result of Lehman's collapse, trading entities realized that no prime broker was too big to fail. Sophisticated trading entities desire to spread their counterparty risk across several prime brokerages and, in order to attract and retain their business, prime brokers support such multi-prime broker relationships.

Trading entities take advantage of prime brokerage service offerings, as well as the capital strength and reserves, of numerous prime brokerage firms by executing transactions with multiple prime brokers. That is, one trading entity may have relationships with more than one prime broker. In a way, this distributed relationship with multiple prime brokers increases the trading entity's opportunity to make trades throughout the market.

However, the distributed relationship with multiple prime brokers also increases the exposure to the trading entity as well as prime brokers who have extended credit and/or act as guarantor(s) of the trades. For example, a trading entity may elect to conduct “away” trades with a willing prime broker (for purposes hereof, referred to as the “executing broker”). In these cases, details regarding the assets and credit arrangements underlying a trade are not known by the executing broker making the trade, and while details regarding assets and credit arrangements are known by the prime broker (for purposes hereof, referred to as the “custodial broker”) who has custody of such assets and/or has established credit arrangements with the trading entity making the trade, details regarding the trade itself are not known by the custodial broker. The details of the trade are actually held by another prime broker, the executing broker. Since the away trades are not executed by the custodial prime broker, information about those trades are hidden from the custodial prime broker until after the end of the trading day, potentially putting the assets and extended credit associated with the trading entity at risk. The risk may be increased when the trading entity makes multiple away trades with multiple, non-custodial prime brokers. None of these non-custodial prime brokers are aware of the away trades conducted by other prime brokers, and the custodial prime broker is not aware of any of these away trades, until possibly after the end of the trading day, thereby further increasing the exposure of the trading entity and the custodial prime broker.

### SUMMARY OF THE INVENTION

The present invention relates to systems and methods for monitoring market transaction activity data to determine when a trading entity has exceeded an aggregated trading limit consisting of one or more trading sub-limits corresponding to one or more custodial prime brokers facilitating trading for the trading entity. The method includes collecting at a centralized hub real time data related to conditions of a trading market from one or more liquidity destinations trading at least one financial article of trade. Trading activity for a trading entity is determined. An aggregate trading limit is determined that is based on one or more trading sub-limits assigned by one or more prime brokers for that trading entity. It is determined when that trading activity exceeds the aggregate trading limit.

Other embodiments are directed to dissemination of one or more cancellation instructions of pending and/or future orders of financial articles of trades that are associated with a particular trading entity. Accordingly, a system for monitoring market transaction activity data is provided that determines when a trading entity has exceeded an aggregate trading limit consisting of one or more trading sub-limits corresponding to one or more custodial prime brokers facilitating trading for the trading entity. The system includes a centralized hub for collecting real time data related to market conditions from a plurality of liquidity destinations trading at least one financial article of trade. The system also includes a tracker that determines trading activity for the trading entity. The system includes an aggregate trading limit that comprises one or more trading sub-limits assigned by one or more custodial prime brokers for the trading entity. The system includes an analyzer that determines when the trading activity exceeds the aggregate trading limit. In another embodiment, the system further comprises a notification engine for providing notification of when the trading activity exceeds the aggregate trading limit.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of a market transaction activity system configured such that a centralized hub is capable of tracking trading activity for a particular trading entity for purposes of determining when that trading activity has exceeded an aggregate trading limit based on trading sub-limits assigned by one or more custodial prime brokers facilitating trading for that trading entity, in accordance with one embodiment of the present invention.

FIG. 2 is a flow diagram illustrating steps in a method for trading activity for purposes of determining when that trading activity has exceeded an aggregate trading limit based on trading sub-limits assigned by one or more custodial prime brokers facilitating trading for that trading entity, in accordance with one embodiment of the present invention.

### DETAILED DESCRIPTION OF THE PREFERRED EMBODIMENTS

Reference will now be made in more detail to the preferred embodiments of the present invention, systems and methods for monitoring market transaction activity data to determine when a trading entity has exceeded an aggregated trading limit consisting of one or more trading sub-limits corresponding to one or more custodial prime brokers facilitating trades for the trading entity, and/or for preventing orders from being processed by a liquidity destination when it is determined that the order puts the market, trading entity, or any associated entity at risk, such as when the aggregate trading limit has been exceeded. While the invention will be described in conjunction with the preferred embodiments, it will be understood that they are not intended to limit the invention to these embodiments. On the contrary, the invention is intended to cover alternatives, modifications and equivalents which may be include within the spirit and scope of the invention.

Accordingly, embodiments of the present invention provide for the centralized collection and normalization of market transaction activity data. In addition, other embodiments of the present invention are capable of reducing the exposure of a trading entity and the corresponding custodial prime brokers by tracking activity of a trading entity in reference to sub-limits set by individual custodial prime brokers who have a relationship with the trading entity.

### Notation and Nomenclature

Embodiments of the present invention can be implemented on a software program, or its corresponding hardware implementations, for processing data through a computer system. The computer system can be a personal computer, notebook computer, server computer, mainframe, networked computer (e.g., router), handheld computer, personal digital assistant, workstation, and the like. This program or its corresponding hardware implementations is operable for enabling the monitoring of market transaction activity data to establish aggregate trading limit based on trading sub-limits assigned by one or more custodial prime brokers for a particular trading entity. In one embodiment, the computer system includes a processor coupled to a bus and memory storage coupled to the bus. The memory storage can be volatile or non-volatile and can include removable storage media. The computer can also include a display, provision for data input and output, etc.

Some portion of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “defining,” “receiving,” “determining,” “comparing,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

### System and Method for Monitoring Market Transaction Activity Data

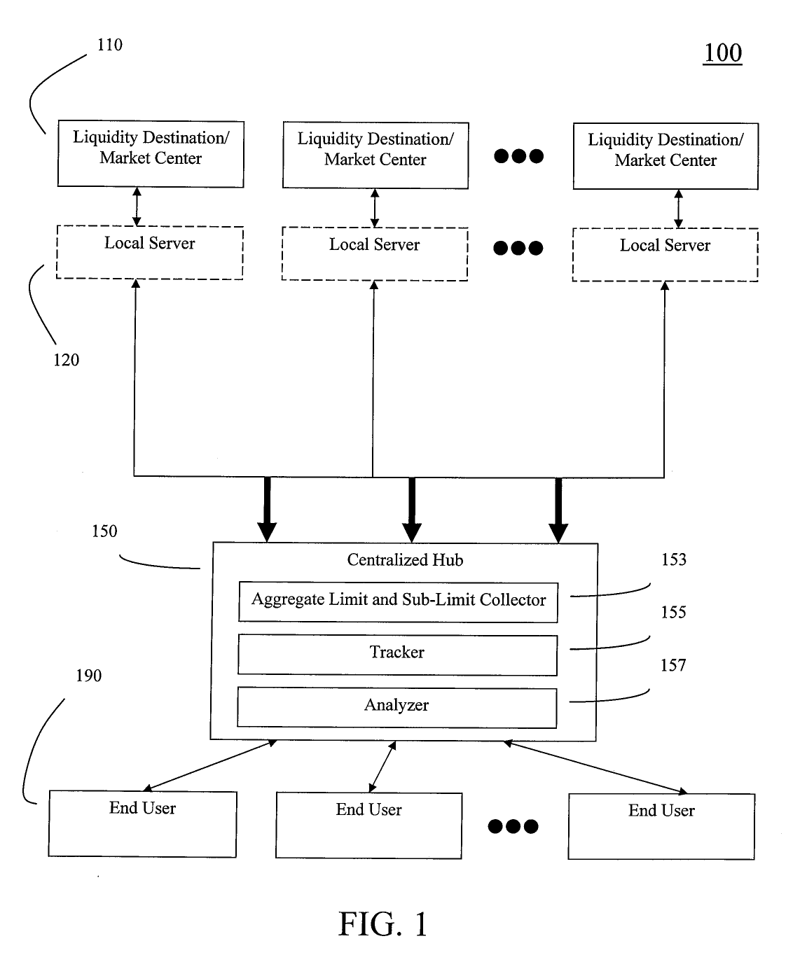

FIG. 1 is a data flow diagram illustrating the flow of information in a data processing system 100 capable of monitoring market transaction activity data from a plurality of liquidity destinations/market centers 110. The subject of this application is a financial article of trade data processing system 100 including various functions, which may be implemented to perform consolidation and analysis of intraday issues related to submitted securities, commodities, options, futures transactions. The system 100 adapts the submitted securities, commodities, options, futures, or other financial articles of trade transaction to involve at least one of disparate systems, multiple parties and multiple liquidity destinations.

Reference to securities or security transactions within this disclosure should be interpreted as transactions involving securities, commodities, options or futures. The term other financial articles of trade transaction refers to any other article traded at the liquidity destinations other than securities, commodities, options, futures. It should be appreciated that different configurations can be used to consolidate and analyze the data to achieve a given result. Although particular combinations are disclosed, variations on those combinations can be used to achieve the same consolidation and analysis in the financial article of trade data processing system 100.

As shown in FIG. 1, market transaction activity data from the plurality of liquidity destinations 110 is shipped to a centralized hub 150. Further processing of the market transaction activity data may occur at various locations. For instance, in one embodiment, the centralized hub 150 receives raw market transaction activity data in real time from each of the liquidity destinations 110 that is trading at least one financial article of trade. Thereafter, the centralized hub 150 provides further processing of the market transaction activity data. In another embodiment, one or more local servers 120 collects real time data at each of the liquidity destinations that is trading at least one financial article of trade. The market transaction activity data is further processed at these local servers 120 and then sent to the centralized hub 150. In still other embodiments, the collection and processing of market transaction activity data can occur at a combination of locations, to include local servers 120 at liquidity destinations and the centralized hub 150. For instance, local servers 120 may only pass on data to the centralized hub 15 without performing substantial processing.

More particularly, the centralized hub 150 is capable of receiving the market transaction activity data from each of the liquidity destinations, whether the data is raw or already processed. Thereafter, the centralized hub 150 is capable of analyzing the data in order to separate out the trading activity of a single trading entity. In this manner, the centralized hub 150 is capable of tracking the trading activity of a single trading entity.

The financial article of trade data processing system 100 of FIG. 1 is capable of identifying particular conditions within the market that are of interest to users of the system 100. In particular, the aggregate limit and sub-limit collector 153 is capable of collecting the data associated with a particular trading entity. For instance, the data collected is in regards to daily or overall trading activity for that trading entity. The analyzer 157 is capable of comparing the collected information relating to trading activity for that trading entity and compare them to predefined aggregate trading limits based on one or more trading sub-limits assigned by custodial prime brokers to the trading entity, as will be described more fully below.

The term “trading entity” is meant to include various types of entities. For instance, a trading entity may be any partner that is involved in executing a financial article of trade. As such, the trading entity may be an individual associated with a market participant identification parameter, broker, prime broker, clearing house, etc. In addition, the term “prime broker” is meant to include any entity that facilitates the trading activity of a particular trading entity. This includes a broker, bank, brokerage house, clearing house, etc.

In particular, the trading entity has relationships with one or more prime brokers who facilitate execution of trading financial articles of trade on one or more liquidity destinations for that trading entity. Each of the prime brokers may have established a trading limit, also referred to as a trading sub-limit, for executing trades for that trading entity. For instance, a prime broker may have set a trading sub-limit of one-hundred thousand dollars to act as a daily ceiling of trading activity. Other examples of trading sub-limits include a total financial amount of trades associated with a particular trading entity, no matter the time period. Still other examples of trading sub-limits, and limits based on those sub-limits are envisioned. The aggregate limit and sub-limit collector 153 determines an aggregate trading limit for a trading entity that is based on one or more trading sub-limits assigned by custodial prime broker for that trading entity.

As such, when the trading entity exceeds the trading sub-limit amount for trades executed with that prime broker, the prime broker will terminate execution of present and/or future trades or order for trades for that trading entity, either through that prime broker or all executions through any prime brokers, in embodiments. In addition, when the trading entity exceeds the aggregate trading limit for trades with any prime broker, execution of trades with one or more prime brokers are terminated, in another embodiment. This analysis considers overnight positions of the trading entity, in one embodiment. In one implementation, the tracker 155 in the centralized hub 150 is able to track the trading activity of the trading entity for a particular prime broker and determine when that trading entity has exceeded its trading sub-limit for that prime broker. Still other implementations are possible, as will be described below.

In another embodiment, the present invention is able to extend the coverage of the trading sub-limit set by a particular custodial prime broker across the market for all trades by a particular trading entity with regard to which such prime broker serves as custodial broker but which trades may be executed through any prime broker. That is, the sub-limit set by one prime broker is applied to all trades executed on behalf of that trading entity with regard to which such prime broker serves as custodial broker. For instance, the tracker 155 of the centralized hub 150 is capable of tracking all trading activity by that trading entity across all liquidity destinations. The tracker 155 is able to keep a running total of the amount executed in trades associated with the trading entity across all liquidity destinations involving any and all prime brokers. As such, the tracker 155 is able to track the trading activity of the trading entity using one or more prime brokers and determine, through an analyzer 157, when that trading entity has exceeded its sub-limit for any trades associated with any particular custodial prime broker. In one embodiment, the overnight position of the trading entity is taken into consideration. Thereafter, one or more present and/or future trades and/or order for trades executed on behalf of that trading entity through one or more prime brokers are terminated.

By enabling the sub-limit for a particular custodial prime broker to be applied to trades executed across using any and all prime brokers on any liquidity destination, this allows that custodial prime broker, which is holding pledged assets and/or which may have extended credit, to take into account “away” trades executed by the trading entity. As discussed previously, the assets backing an away trade are not held by the executing prime broker making the trade, but are actually held by the custodial prime broker. Also, any additional credit backing an away trade was not extended by the executing prime broker making the trade, but was extended by the custodial prime broker. Normally, these away trades are hidden from the custodial prime broker. In particular, the amounts involving away trades are hidden from that prime broker. However, embodiments of the present invention are able to account for those away trades and associate those away trades with a trading entity. As such, any trading sub-limit placed on that trading entity may be compared to all or a sub-set of the trading activity of that trading entity across all liquidity destinations which is associated with a particular custodial prime broker.

In still another embodiment, information regarding each execution of a financial article of trade includes where the assets and/or credit backing that trade are held. For instance, if a trade is executed by Prime Broker B, acting as a non-custodial prime broker, but the assets and/or credit backing that trade are held and/or extended by Prime Broker A, acting as a custodial prime broker, that information is collected by the centralized hub 150. In that case, all trades executed on behalf of a trading entity, and using assets and/or credit that are backed and/or extended by a particular prime broker can be tracked by tracker 155. That custodial prime broker may set a trading sub-limit based on the assets held and/or credit extended by the prime broker on behalf of the trading entity. As such, the tracker 155 in the centralized hub 150 is able to track the trading activity of the trading entity that is using one or more prime brokers, parse out a sub-set of trades, from an overall set of trades associated with the trading entity, that are pledged against assets and/or credit of a particular prime broker, track the trading activity of the trading entity for trades pledged against those assets and/or credit forming the sub-set of trades, and determine, through the analyzer 157, when that trading activity involving the sub-set of trades has exceeded its trading sub-limit for the custodial prime broker holding those assets and/or extending that credit. As such, one or more present and/or future trades and/or orders for trades for the trading entity executed through one or more prime brokers are terminated by an action module to reduce the risk of the trading entity or any prime brokers associated with the trading entity. In one implementation, a subset of the trades including one or more present and/or future trades or orders for trades that are pledged against assets and/or credit of a particular prime broker are terminated.

In addition, the trading entity may have multiple relationships with various custodial prime brokers. Each of the prime brokers may have established a trading sub-limit for that trading entity. For example, Prime Broker A may have a sub-limit of three-hundred thousand dollars with the trading entity, Prime Broker B may have a sub-limit of half a million dollars with the trading entity, and Prime Broker C may have a sub-limit of one million dollars with that trading entity. For various reasons, the sub-limit set by one prime broker for a trading entity is private information, and hidden from other prime brokers.

In one embodiment, the trading sub-limit of each of the prime brokers in association with a trading entity are totaled to create an aggregated limit. In the above example, for the trading entity in question, the aggregated limit includes sub-limits for Prime Broker A ($300,000), Prime Broker B ($500,000), and Prime Broker C ($1,000,000). As such, the aggregated limit is $1,800,000 for that trading entity.

One embodiment of the present invention is able to extend the coverage of all the trading sub-limits set by one or more prime brokers across the market for all trades made by that trading entity. That is, the aggregate trading limit, based on trading sub-limits for associated prime brokers or custodial prime brokers, is applied indiscriminately to all trades executed on behalf of that trading entity. The trading sub-limits for each of the prime brokers is known to the system of the present invention. For instance, the tracker 155 of the centralized hub 150 is capable of tracking all trading activity by that trading entity across all liquidity destinations. The tracker 155 is able to keep a running total of the amount executed in trades associated with the trading entity across all liquidity destinations involving any and all prime brokers. As such, the tracker 155 is able to track the trading activity of the trading entity using one or more prime brokers and determine, through the analyzer 157, when that trading entity has exceeded its aggregate trading limit for all associated prime brokers. In one embodiment, the overnight position of the trading entity is taken into consideration. When the aggregate trading limit has been exceeded, one or more present and/or future trades or orders for trades executed on behalf of the trading entity through one or more prime brokers are terminated for purposes of risk management for the trading entity and/or any prime brokers associated with the trading entity, such as any custodial prime brokers.

Moreover, embodiments of the present invention enable users to take action promptly on an intraday basis to minimize market exposure of a trading entity that is executing trades with multiple prime brokers. In particular, the financial article of trade data processing system 100 of FIG. 1 is capable of identifying particular conditions within the market that are of interest to users of the processing system. As a result, once those market conditions are identified and notification of such is presented through a notification engine, the users and/or implementations of the present invention can react accordingly to address those market conditions. For instance, whenever a trading sub-limit assigned by a prime broker to a trading entity has been exceeded for all trades executed on behalf of that trading entity across one or more, or all liquidity destinations and across one or more, or all prime brokers, notice of such event may be given. In one embodiment, those trades are backed by assets and/or credit from the prime broker assigning the sub-limit. The notice may be given to the prime broker whose sub-limit has been exceeded. Alternatively, or in conjunction with the above, an instruction is given by an action module (not shown) to all liquidity destinations to terminate all transactions, or a specific subset of transactions, involving that trading entity. Additionally, whenever an aggregate limit, based on trading sub-limits for all associated prime brokers, for a particular entity has been exceeded for all trades executed on behalf of that trading entity across one or more, or all liquidity destinations and across one or more, or all prime brokers, notice of such event may be given. That notice may be given to one or more prime brokers whose sub-limits are involved. Further action may be taken by the prime brokers themselves, or through implementations of the present invention. For instance, alternatively, or in conjunction with the above, an instruction by the action module (not shown) is given to all liquidity destinations to terminate all or a specific subset of transactions involving that trading entity.

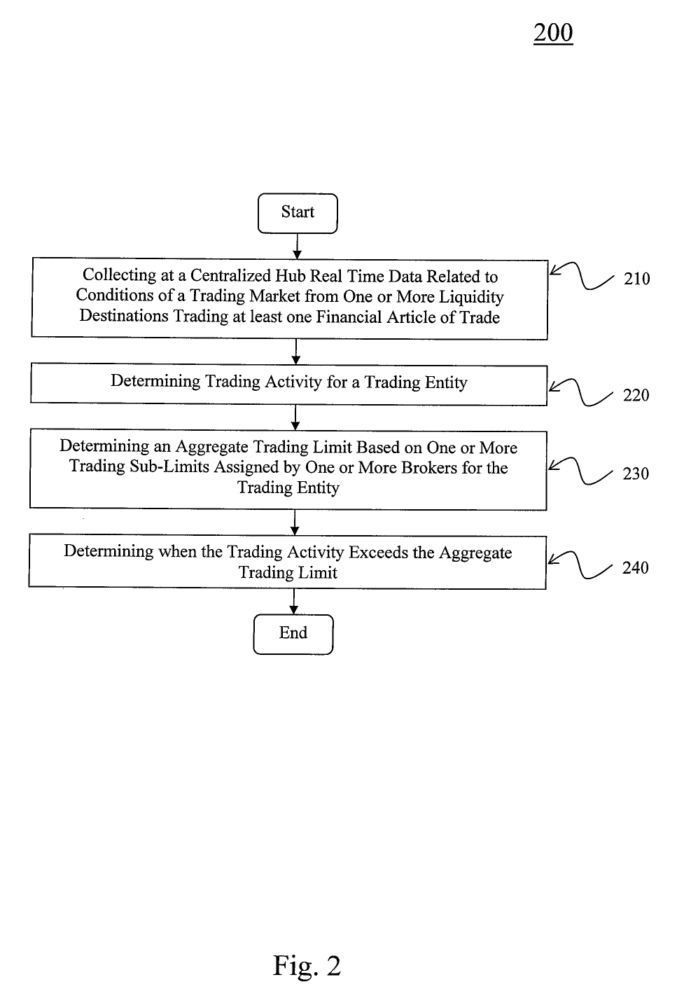

FIG. 2 is a flow diagram 200 illustrating steps in a method for monitoring trading activity for purposes of determining when that trading activity has exceeded an aggregate trading limit based on trading sub-limits assigned by one or more custodial prime brokers facilitating trading for that trading entity, in accordance with one embodiment of the present invention. The method of flow diagram 200 is implemented within system 100 of FIG. 1, in one embodiment.

Real time data is collected at a centralized hub 210. The real time data is related to conditions of a trading market from one or more liquidity destinations trading at least one financial article of trade. As previously described, the centralized hub is capable of receiving the market transaction activity data from each of the liquidity destinations, whether the data is raw or already processed.

Trading activity is determined for a trading entity 220. The trading activity may be executed through one or more prime brokers through one or more liquidity destinations. In that manner, most if not all of the trades executed on behalf of the trading entity are collected monitored, and analyzed for purposes of performing risk management.

In addition, an aggregate trading limit is determined for the trading entity 230. The aggregate trading limit is based on one or more trading sub-limits assigned by one or more prime brokers for that trading entity. In one implementation, the aggregate trading limit includes two or more trading sub-limits. In another implementation, the aggregate trading limit includes only one trading sub-limit, such that risk analysis is performed based on that trading sub-limit across all of the trades or a subset of the trades executed on behalf of the trading entity.

By tracking the trades executed on behalf of the trading entity through one or more prime brokers, it is determined when the trading activity exceeds the aggregate trading limit 240. In this manner, risk analysis may be performed on all of the trades executed on behalf of the trading entity, or a subset of the trades executed on behalf of the trading entity.

For instance, in one embodiment, the aggregate trading limit includes a single trading sub-limit for a custodial prime broker. Trades executed on behalf of that trading entity that are executed through that custodial prime broker are tracked and monitored. In this manner, it is determined when transactions, including trades or orders for trades, executed through that custodial prime broker on behalf of the trading entity have exceeded the trading sub-limit, as set by that custodial prime broker. As such, this provides an alternative tracking mechanism to the internal system used by the custodial prime broker.

In another embodiment, the aggregate trading limit includes a single trading sub-limit for a custodial prime broker. Trades executed on behalf of the trading entity that are executed through one or more prime brokers, including the custodial prime broker, are tracked and monitored. In this manner, it is determined when all transactions, including trades and/or orders for trades, executed through the one or more prime brokers on behalf of the trading entity exceed the trading sub-limit, as set by the custodial prime broker.

In still another embodiment, the aggregate trading limit includes a single trading sub-limit for a custodial prime broker. Trades executed on behalf of the trading entity that are executed through one or more prime brokers, including the custodial prime broker, are tracked and monitored. In addition, a subset of those trades executed through the one or more prime brokers are tracked and monitored. The subset of trades include trades that are pledged against assets and/or credit of a particular custodial prime broker. In this manner, it is determined when trading activity involving the sub-set of trades has exceeded its trading sub-limit for the custodial prime broker holding those assets and/or extending that credit.

In still another embodiment, the aggregate trading limit includes two or more trading sub-limits. As before, trades executed on behalf of the trading entity that are executed through one or more prime brokers are tracked and monitored. A running total of the amount executed in trades associated with the trading entity across all liquidity destinations involving any and all prime brokers is determined. In this manner, it is determined when trading activity executed through one or more prime brokers has exceeded the aggregate trading limit. As such, the aggregate trading limit, based on trading sub-limits for associated custodial prime brokers, is applied indiscriminately to all trades executed on behalf of that trading entity.

Whenever a trading sub-limit or an aggregate trading limit has been exceeded, addition action is taken to minimize market exposure of a trading entity that is executing trades with multiple prime brokers, in embodiments. For instance, whenever a trading sub-limit assigned by a prime broker or an aggregate trading limit of a trading entity has been exceeded for all trades or a subset of trades executed on behalf of that trading entity across one or more, or all liquidity destinations and across one or more, or all prime brokers, notice of such event may be given. Alternatively, or in conjunction with the above, an instruction is given to all liquidity destinations to terminate all present and/or future transactions, or a specific subset of transactions, involving that trading entity.

For example, whenever an aggregate limit, based on trading sub-limits for all associated prime brokers, for a particular entity has been exceeded for all trades executed on behalf of that trading entity across one or more, or all liquidity destinations and across one or more, or all prime brokers, notice of such event may be given. That notice may be given to one or more prime brokers whose sub-limits are involved. Alternatively, or in conjunction with the above, an instruction is given to all liquidity destinations to terminate all or a specific subset of present and/or future transactions involving that trading entity. That is, one or more present and/or future trades and/or orders for trades executed on behalf of the trading entity through one or more prime brokers are terminated so that the trading entity is in compliance with the aggregate trading limit.

A system and method for monitoring market transaction activity data to determine when a trading entity has exceeded an aggregated trading limit consisting of one or more trading sub-limits corresponding to prime brokers facilitating trades for the trading entity is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The one or more present inventions, in various embodiments, include components, methods, processes, systems and/or apparatus substantially as depicted and described herein, including various embodiments, subcombinations, and subsets thereof. Those of skill in the art will understand how to make and use the present invention after understanding the present disclosure.

The present invention, in various embodiments, includes providing devices and processes in the absence of items not depicted and/or described herein or in various embodiments hereof, including in the absence of such items as may have been used in previous devices or processes (e.g., for improving performance, achieving ease and/or reducing cost of implementation).

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention (e.g., as may be within the skill and knowledge of those in the art, after understanding the present disclosure). It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

We claim:

1. A method for monitoring market transaction activity data, comprising:
collecting at a centralized hub real time data related to conditions of a trading market from one or more liquidity destinations trading at least one financial article of trade;
determining trading activity for a trading entity;
determining an aggregate trading limit based on one or more trading sub-limits assigned by one or more prime brokers for said trading entity;
determining when said trading activity exceeds said aggregate trading limit.

2. The method of claim 1, wherein said determining trading activity comprises:
determining trading activity for said trading entity executed through a custodial prime broker, wherein said trading activity comprises trades backed by assets held by said custodial prime broker for the benefit of said trading entity, wherein said aggregate trading limit comprises a trading sub-limit assigned by said custodial prime broker for said trading entity; and
determining when said trading activity exceeds said trading sub-limit.

3. The method of claim 1, wherein said determining trading activity comprises:
determining trading activity for said trading entity executed through a plurality of prime brokers, wherein said aggregate trading limit comprises a trading sub-limit assigned by a custodial prime broker for said trading entity; and
determining when said trading activity exceeds said trading sub-limit.

4. The method of claim 1, wherein said determining trading activity comprises:
determining trading activity for said trading entity executed through a plurality of prime brokers, wherein said aggregate trading limit comprises a trading sub-limit assigned by a custodial prime broker for said trading entity;
determining a subset of said trading activity that includes trades backed by assets held by said custodial prime broker for the benefit of said trading entity; and
determining when said subset of said trading activity exceeds said trading sub-limit.

5. The method of claim 1, wherein said determining trading activity comprises:
determining a first trading sub-limit assigned by a first custodial prime broker for said trading entity;
determining a second trading sub-limit assigned by a second custodial prime broker for said trading entity; and
determining when said trading activity exceeds an aggregate of said first sub-limit and second trading sub-limit as said aggregate trading limit.

6. The method of claim 5, further comprising:
determining a subset of said trading activity that includes trades backed by first assets held by said first custodial prime broker for the benefit of said trading entity and trades backed by second assets held by said second custodial prime broker for the benefit of said trading entity.

7. The method of claim 1, wherein said determining trading activity comprises:
determining a plurality of trading sub-limits assigned by a plurality of custodial prime brokers for said trading entity;
aggregating said plurality of trading sub-limits to obtain said aggregate trading limit; and
determining when said trading activity executed through a plurality of prime brokers exceeds said aggregate trading limit.

8. The method of claim 1, further comprising:
providing notification of when said trading activity exceeds said aggregate trading limit.

9. The method of claim 1, further comprising:
performing an action terminating trading activity of said trading entity.

10. The method of claim 1, further comprising:
normalizing said real time data that is collected into a standard form; and
storing said real time data that is normalized.

11. A method for monitoring market transaction activity data, comprising:
collecting at a centralized hub real time data related to conditions of a trading market from one or more liquidity destinations trading at least one financial article of trade;
determining a trading sub-limit assigned by a custodial prime broker for a trading entity;
determining trading activity for a trading entity; and
determining when said trading activity exceeds said trading sub-limit.

12. The method of claim 11, wherein said determining trading activity further comprises:
determining trading activity of said trading entity executed through a plurality of prime brokers.

13. The method of claim 12, wherein said plurality of prime brokers includes said custodial prime broker.

14. The method of claim 11, further comprising:
providing notification of when said trading activity exceeds said trading sub-limit.

15. The method of claim 11, further comprising:
normalizing said real time data that is collected into a standard form; and
storing said real time data that is normalized.

16. A method for monitoring market transaction activity data, comprising:
collecting at a centralized hub real time data related to conditions of a trading market from one or more liquidity destinations trading at least one financial article of trade;
determining a trading sub-limit assigned by a custodial prime broker for a trading entity;
determining trading activity for a trading entity;
determining a subset of said trading activity that includes trades backed by assets held by said custodial prime broker for the benefit of said trading entity; and
determining when said subset of said trading activity exceeds said trading sub-limit.

17. The method of claim 16, wherein said determining trading activity comprises:
determining only trading activity for said trading entity executed through said custodial prime broker.

18. The method of claim 16, wherein said determining trading activity comprises:
determining trading activity for said trading entity executed through a plurality of prime brokers.

19. The method of claim 18, wherein said plurality of prime brokers includes said custodial prime broker.

20. A system for monitoring market transaction activity data, comprising:
a centralized hub for collecting real time data related to market conditions from a plurality of liquidity destinations trading at least one financial article of trade;
a tracker for determining trading activity for a trading entity;
an aggregate trading limit comprising one or more trading sub-limits assigned by one or more custodial prime brokers for said trading entity;
an analyzer for determining when said trading activity exceeds said aggregate trading limit.

21. The system of claim 20, wherein said aggregate trading limit comprises a single trading sub-limit assigned by a custodial prime broker, and wherein said trading activity comprises trades executed by said custodial prime broker.

22. The system of claim 20, wherein said aggregate trading limit comprises a single trading sub-limit assigned by a custodial prime broker, and wherein said trading activity comprises trades executed by a plurality of prime brokers.

23. The system of claim 20, wherein said aggregate trading limit comprises a single trading sub-limit assigned by a custodial prime broker, and wherein said trading activity comprises trades that are executed through a plurality of prime brokers.
